(19) United States
(12) Patent Application Publication
(10) Pub. No.: US 2025/0355554 A1
(43) Pub. Date: Nov. 20, 2025

(54) INPUT DEVICE, IMAGE DISPLAY METHOD AND PROGRAM

(71) Applicant: NIDEC INSTRUMENTS CORPORATION, Nagano (JP)

(72) Inventor: Yosuke OGUCHI, Nagano (JP)

(21) Appl. No.: 19/211,285

(22) Filed: May 19, 2025

(30) Foreign Application Priority Data
May 20, 2024 (JP) 2024-081785

(51) Int. Cl. G06F 3/04847; G06F 3/04817

(52) U.S. Cl. CPC G06F 3/04847; G06F 3/04817

(57) ABSTRACT

An input device for acquiring input information related to a medium includes a display part which is capable of displaying images including icons for inputting the input information, an input part which acquires a position of an icon of the display part as the input information when the position of the icon is instructed, and a control part which acquires the input information from the input part and controls the display part. The display part is formed with a protruded part in a portion indicating a boundary position and/or a center position of an icon, and the control part adjusts appearance of a portion corresponding to the protruded part of the image.

### CROSS REFERENCE TO RELATED APPLICATION

The present invention claims priority under 35 U.S.C. § 119 to Japanese Application No. 2024-081785 filed May 20, 2024, the entire content of which is incorporated herein by reference.

### TECHNICAL FIELD

At least an embodiment of the present invention may relate to an input device, an image display method and a program.

### BACKGROUND ART

Conventionally, when settlement of a card-shaped medium (hereinafter, the card-shaped medium is simply referred to as a “card”) is to be performed, an input device such as a PIN pad used for inputting information such as a Personal Identification Number (hereinafter, referred to as a “PIN”) and a card reader integrated with the PIN pad has been known.

In such a conventional input device, when physical buttons are used, a projection is provided on a button of the numeral “5” so that even visually-impaired person is capable of identifying numeric arrangement of buttons. In conventional numeric arrangement of buttons for a visually-impaired person, Japanese Laid-Open Patent Application No. Hei 10-190797 (Patent Literature 1) discloses a cell-phone in which a flexible sheet member provided with braille is added on operation buttons.

On the other hand, in an input device in recent years, in addition to a type in which buttons such as a ten-key pad are disposed physically, there is a device in a type in which a PIN input screen is displayed on a display such as a liquid crystal and buttons on the screen are touch-inputted (hereinafter, referred to as a “display type”).

In the conventional display type input device, as described in Patent Literature 1, when positions of buttons are shown for a visually-impaired person by attaching a sheet member formed with a projection to its display surface, the projection causes irregular reflection of light and an image displayed at the projection becomes difficult to be seen.

### SUMMARY

In view of the problem described above, at least an embodiment of the present invention may advantageously provide an input device in which influence due to that a displayed image becomes difficult to be seen by a protruded part is suppressed.

According to at least an embodiment of the present invention, there may be provided an input device for acquiring input information related to a medium. The input device includes a display part which is capable of displaying images including icons for inputting the input information, an input part which acquires a position of an icon of the display part as the input information when the position of the icon is instructed, and a control part which acquires the input information from the input part and controls the display part. The display part is formed with a protruded part in a portion indicating a boundary position and/or a center position of an icon, and the control part adjusts appearance of the image in a portion corresponding to the protruded part. According to this structure, influence due to that a displayed image becomes difficult to be seen by the protruded part for a visually-impaired person can be suppressed.

The input device in accordance with an embodiment of the present invention is characterized in that the icon is an input button image of a numeral, a character or a symbol. According to this structure, while displaying icons of input buttons of a numeral, a character or a symbol for PIN input, a situation that other normal images become difficult to be seen can be prevented.

The input device in accordance with an embodiment of the present invention is characterized in that the control part adjusts brightness of a portion corresponding to the protruded part of the display part, and/or adjusts a display of a portion corresponding to refraction of light in the protruded part. According to this structure, irregular reflection of light by the protruded part is suppressed, and/or a feeling of strangeness of appearance of the protruded part can be restrained.

An image display method in accordance with an embodiment of the present invention is an image display method performed by an input device for acquiring input information related to a medium. The input device includes a display part which is capable of displaying images including icons for inputting the input information, an input part which acquires a position of an icon of the display part as the input information when the position of the icon is instructed, and a control part which acquires the input information from the input part and controls the display part. The display part is formed with a protruded part in a portion indicating a boundary position and/or a center position of an icon, and appearance of the image in a portion corresponding to the protruded part is adjusted. According to this structure, influence due to that a displayed image becomes difficult to be seen by the protruded part for a visually-impaired person can be suppressed.

A program in accordance with an embodiment of the present invention is a program which is executed by an input device for acquiring input information related to a medium. The input device includes a display part which is capable of displaying images including icons for inputting the input information, an input part which acquires a position of an icon of the display part as the input information when the position of the icon is instructed, and a control part which acquires the input information from the input part and controls the display part. The display part is formed with a protruded part in a portion indicating a boundary position and/or a center position of an icon, and appearance of the image in a portion corresponding to the protruded part is adjusted by the control part. According to this structure, influence due to that a displayed image becomes difficult to be seen by the protruded part for a visually-impaired person can be suppressed.

### Effects of the Invention

According to the embodiment of the present invention, a protruded part is formed in a portion indicating a boundary position and/or a center position of an icon for inputting input information on a display part, and appearance of an image in a portion corresponding to the protruded part is adjusted. As a result, an input device is provided in which a situation that a displayed image becomes difficult to be seen by the protruded part is suppressed.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a plan view showing an outside appearance structure of a card reader in accordance with an embodiment of the present invention.

FIG. 2 is a system configuration diagram of the card reader shown in FIG. 1.

FIG. 3 is a flowchart showing image display adjustment processing in accordance with an embodiment of the present invention.

FIGS. 4A and 4B are screen examples of the image display adjustment processing shown in FIG. 3.

### DETAILED DESCRIPTION

### Embodiments

### [Structure of Card Reader 1]

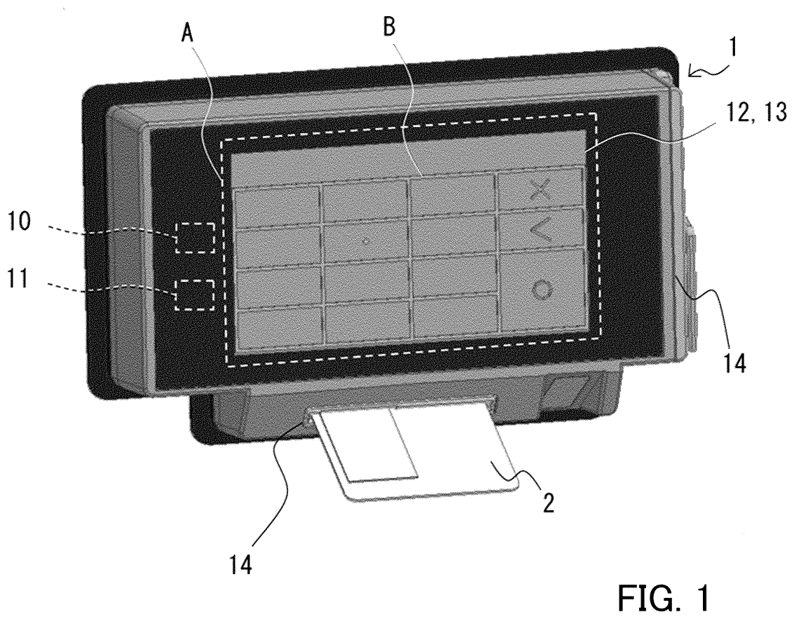

First, an outside appearance structure of a card reader 1 in accordance with an embodiment of the present invention will be described below with reference to FIG. 1. The card reader 1 in this embodiment is an example of a display type input device in which a display part 12 that is a display and an input part 13 that is a touch panel are integrally formed with each other as a touch panel display.

In this embodiment, the display part 12 is capable of displaying various images such as an PIN input screen including icons for inputting input information, advertisements such as a moving image or a still image, selection of settlement methods, and settlement results. Among these images, icons of the images may be, as described below, touch input code (symbol) images of, for example, numerals such as ten-keys, characters or symbols. Specifically, the input symbols may, for example, correspond to numerals, characters, symbols and the like, and may be images of buttons which can be visually recognized by a non-disabled person.

In addition, in this embodiment, a protruded part “B” is formed at a position indicating a boundary position and/or a center position of an icon of the display part 12. The protruded part “B” may be, for example, resin which is printed for a visually-impaired person by an inkjet printer or the like so as to swell (protrude) on a surface of a protective film on glass of the display unit 12. Specifically, as the protruded part “B”, a transparent protruded part may be formed which is formed in a thickness of about 0.1 through several millimeters.

In this embodiment, as the protruded part “B”, as described below, a protruded part in a lattice shape is formed at a boundary of respective button images such as ten keys. In addition, a projection in a circular convex lens shape is formed at a center of a button image of the numeral “5”. The “center” does not necessarily mean a center of a diagonal of a square of a button or a center of a circle, and may be a position indicating a button of the center numeral such as “5”. Further, the “center” may be expanded to some extent.

When the protruded part “B” is formed of transparent resin as described above, a user having no visual impairment is not prevented from recognizing button images. Further, the transparent resin moderately gets wet (sagged) and thus, a signature or the like can be smoothly performed by a finger without a sense of being caught.

In this embodiment, as described below, image adjustment processing is performed by the control part 10 so as to prevent an image from becoming difficult to be seen due to scattering of light by the protruded part “B”. The control part 10, for example, performs the image adjustment processing by executing a program stored in a storage part 11.

Further, the card reader 1 in accordance with this embodiment is provided with an information reading and writing part 14 which includes a magnetic head, an IC contact block, an antenna “A” for a non-contact type IC and the like for reading and writing to a card 2.

In addition, the card reader 1 may, for example, include an interface for being connected with a host apparatus 3 described below, LEDs for displaying a status and the like as other necessary circuits, a device, a mechanism and the like.

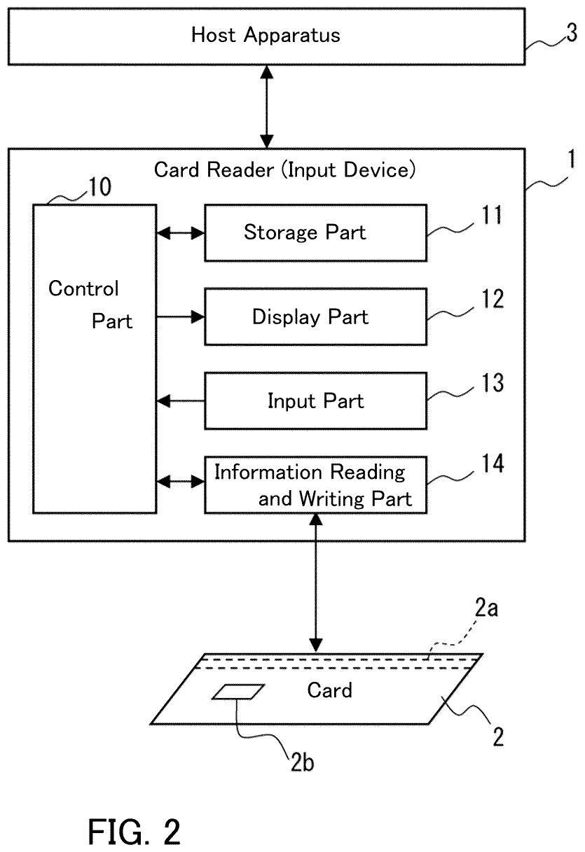

Next, a system configuration of the card reader 1 in accordance with this embodiment will be described below with reference to FIG. 2. The card reader 1 in this embodiment is, as an example, a card reader which is capable of reading or writing information between a medium including a card 2 and the card reader 1 by instructions of the host apparatus 3.

In this embodiment, the card reader 1 may include functions of a magnetic card leader reading and writing to a magnetic stripe of a card 2, a contact type IC card reader reading and writing card information to a contact type IC of a card 2, and a non-contact type IC card reader reading and writing to a non-contact type IC of a card 2.

The card 2 is an example of a medium in this embodiment. In this embodiment, the card 2 may be a magnetic recording medium, a contact type IC card and/or a non-contact type IC card.

In this embodiment, the card 2 may be, for example, a rectangular card made of vinyl chloride whose thickness is about 0.7-0.8 mm. The card 2 may be formed with a magnetic stripe 2a where a magnetic signal is stored. Further, in this embodiment, the card 2 may be provided with an IC chip 2b which is an IC chip (hereinafter, referred to as a “contact type IC”) having contact points (external terminal) exposed on a card surface, and a non-contact type IC which may be used as the IC chip 2b is built in the card. In other words, in the card 2, the contact type IC and the non-contact type IC are structured of the same IC chip, or may be structured in separate IC chips.

In the IC chip 2b of a card 2, for example, various types of application software (hereinafter, simply referred to as an “application”) for executing settlement of a credit card, settlement of a debit card, settlement of other points, and the like and various data are stored in recording media such as a flash memory or an EEPROM (Electrically Erasable Programmable Read-Only Memory). Further, the IC chip 2b of a card 2 may include an MPU (Micro Processing Unit).

The card 2 may be a PET (polyethylene terephthalate) card whose thickness is about 0.18-0.36 mm or a paper card having a predetermined thickness. In addition, the card 2 may be a recording medium of NFC (Near Field Communication) which is incorporated with an electromagnetic induction antenna and is provided with a function of a non-contact type IC card. Further, in this embodiment, in addition to a card 2, a non-contact medium such as a smartphone, cell-phone, smart watch, IC tag with a wireless function (RFID tag, Radio Frequency Identifier Tag) may be used.

The host apparatus 3 includes, for example, an ATM (Automated Teller Machine), POS (Point Of Sales) terminal, cash register, PC (Personal Computer) for settlement, settlement terminal in a hospital or the like, store server, terminal for other settlement, Kiosk terminal, payment terminal of a gas station, roadside apparatus, on-vehicle apparatus in a taxi and the like, ticket issuance system of transportation, point card settlement system in a convenience store and the like, member card issuance system in a retail store, card issuance and payment system of a game machine, entrance and exit management system, and the like (hereinafter, simply referred to an “ATM and the like”).

In this embodiment, the card reader 1 and the host apparatus 3 are connected with each other through USB (Universal Serial Bus), RS-232C, LAN (Local Area Network) such as Ethernet (registered trademark), or other dedicated interfaces, and the like (hereinafter, simply referred to “USB and the like”).

Next, a control configuration and a function configuration of the card reader 1 will be described below. The card reader 1 includes, as its control configuration, a control part 10, storage part 11, display part 12, input part 13 and information reading and writing part 14.

The control part 10 includes a CPU (Central Processing Unit), MPU, DSP (Digital Signal Processor), ASIC (Application Specific Integrated Circuit), GPU (Graphics Processing Unit), and the like (hereinafter, simply referred to as “CPU and the like”).

In this embodiment, the control part 10 draws and displays an image stored in the storage part 11. Specifically, in this embodiment, the control part 10 functions as an image adjustment part which adjusts appearance of an image display in a portion corresponding to the protruded part “B”.

The storage part 11 is a non-transitory recording medium such as a RAM (Random Access Memory), ROM including a flash memory, HDD (Hard Disk Drive) or an optical recording medium. In this embodiment, the ROM of the storage part 11 stores various set values, programs, temporary data and the like. The programs include OS (Operating System), device driver, middleware, various applications and the like. Among these programs, the various applications may include settlement application for executing various types of processing relating to a magnetic recording medium, contact type IC and non-contact type IC card reader. Further, in this embodiment, the program includes an image processing program relating to a device driver which executes an image display adjustment processing adjusting appearance of the image in a portion corresponding to the protruded part “B”.

Further, in a RAM and the like of the storage part 11 in this embodiment, a region of a frame buffer is secured for temporarily storing an image which is displayed in the display part 12. The frame buffer may be a single buffer or a double buffer. In addition, the storage part 11 may store mask image data for determining whether appearance of pixels displayed at a position under the protruded part “B” on the display part 12 is adjusted or not. The mask image data may be data whose pixel size is the same as a display region of the display part 12 and, in each pixel, a height value of a portion where the protruded part “B” is formed is set to be “1” and a portion where not formed is set to be “0”. The mask image data may be, for example, created based on image data which are used when the protruded part “B” is printed by an inkjet printer or the like.

The display part 12 includes a liquid crystal display, organic electro-luminescence display (including organic light emitting diode display), fluorescent display tube (Vacuum Fluorescent Display), electronic paper, LED (Light Emitting Diode) for state display, and the like. In this embodiment, the display part 12 is capable of displaying several kinds of non-contact communication marks, settlement states, selection displays of a user, and the like.

The input part 13 includes a resistance type or a capacitance type touch panel, touchpad, camera, fingerprint or vein sensor formed on glass, and other various sensors. The input part 13 acquires input information related to a medium of a user. In this embodiment, an example is described in which the display part 12 and the input part 13 are structured as an integrated touch panel display.

In this embodiment, when the input part 13 which is a touch panel is instructed by pressing the display part 12 with a finger of a user or the like, the input part 13 acquires the pressed coordinate (position), a code corresponding to the displayed icon, and the like as input information. For example, the input part 13 acquires a numeral, character or symbol corresponding to a position of an icon as input information and thereby, information such as PIN can be acquired. Alternatively, for example, the input part 13 acquires data of continuously pressed position and thereby, the input part 13 is also capable of acquiring a signature of a user as input information.

The information reading and writing part 14 is a magnetic head, IC contact block and/or antenna “A” and the like, which perform reading and/or writing of information (medium information) with respect to a medium including a card 2.

In the information reading and writing unit 14, the magnetic head includes a head which reads and writes a magnetic signal of a magnetic stripe 2a of a card 2, an encoding and decoding circuit, and the like. The magnetic head may be an encryption head which performs reading and writing of encrypted magnetic signal. In this embodiment, a card 2 is slid along a groove by a user and thereby, the magnetic head is capable of reading and writing medium information which is magnetic information. Alternatively, the IC contact block includes a terminal, mechanism and circuit which perform reading and writing information with respect to an IC chip 2b of a card 2. In this embodiment, the IC contact block is brought into contact with an external terminal of an IC chip 2b of a card 2 which is inserted into an IC insertion part and performs reading and writing of information. Alternatively, the antenna “A” is capable of performing non-contact communication by bringing a non-contact medium including a card 2 closer to the antenna “A”.

### [Image Display Adjustment Processing]

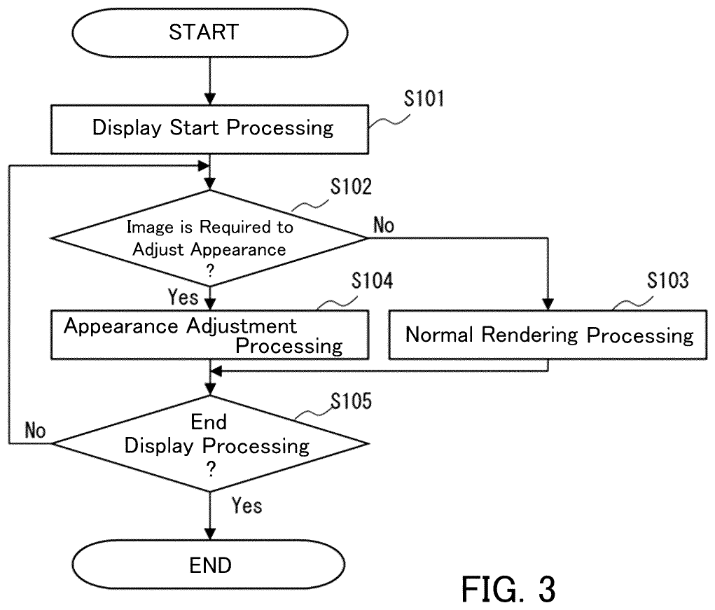

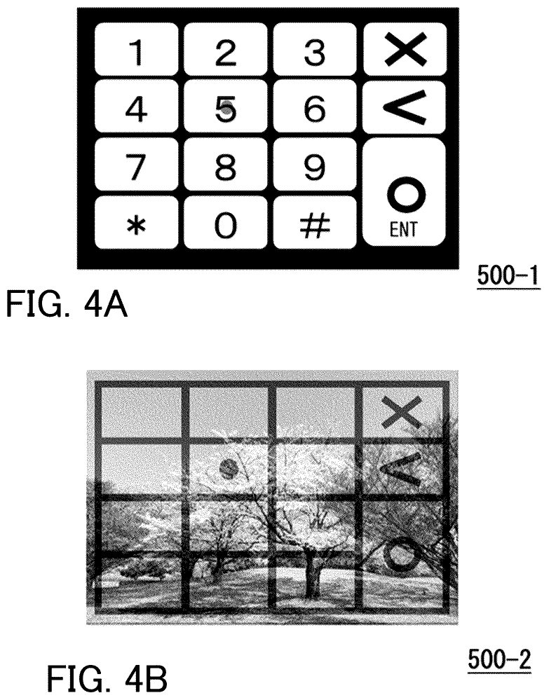

Next, an image display adjustment processing in accordance with an embodiment of the present invention will be described below with reference to FIG. 3 and FIGS. 4A and 4B. In the image display adjustment processing in this embodiment, appearance of a portion of an image corresponding to the protruded part is adjusted by the card reader 1. In this case, processing is performed in which brightness of the portion corresponding to the protruded part in the display part 12 is adjusted and/or, a display of the portion corresponding to the refraction of the light in the protruded part is adjusted. The image display adjustment processing in this embodiment is performed so that the control part 10 mainly executes a program stored in the storage part 11 by using hardware resources in cooperation with respective parts. The image display adjustment processing is processing for executing an image display method in accordance with an embodiment of the present invention which is executed by the control part 10. Next, details of the image display adjustment processing will be described below for each step with reference to the flowchart shown in FIG. 3.

### (Step S101)

First, the control part 10 performs display start processing. The control part 10 displays an input screen for the PIN, advertisements such as a moving image or a still image, selection of settlement methods, a settlement result, and the like on the display part 12 in response to instructions from the host apparatus 3. Therefore, the control part 10 secures a frame buffer in a RAM of the storage unit 11 and reads out data of the images from the storage part 11 into the frame buffer to prepare drawing (rendering).

### (Step S102)

Next, the control part 10 determines whether the image is required to adjust its appearance or not. In a case that the image is image data (hereinafter, referred to as a “normal image”) such as normal moving images or advertisements acquired from the outside, which are not set in an image layout for avoiding the protruded part “B”, the control part 10 judges that appearance adjustment to the protruded part “B” is required and determines “Yes”. On the other hand, in a case that the image is image data (hereinafter, referred to as an “adjusted image”) such as an input screen of the PIN, advertisements such as a moving image or a still image processed in advance, selection of settlement methods, a settlement result, and the like, which are set in an image layout for previously avoiding the protruded part “B”, the control part 10 determines “No” to perform normal rendering. In the case of “Yes”, the control part 10 advances the processing to the step S104. In the case of “No”, the control part 10 advances the processing to the step S103.

### (Step S103)

When normal rendering is to be performed, the control part 10 performs normal rendering processing. The control part 10 does not perform appearance adjustment with respect to the adjusted image and thus, the control unit 10 performs normal rendering. The control part 10 reads out image data of an image stored in a ROM or the like of the storage part 11 and renders to a frame buffer.

The screen 500-1 in FIG. 4A is an example of a PIN input screen which is performed with normal rendering. In this example, images of numeral, character or symbol buttons are drawn as respective icon images. Further, a protruded portion of the protruded part “B” in a lattice shape corresponding to a boundary of the icon may be rendered in black color. In addition, a protruded portion at a center of the button image of “5” may be rendered with an image whose brightness has been lowered in advance.

### (Step S104)

In a case that appearance adjustment is to be performed, the control part 10 performs appearance adjustment processing. The control part 10 performs adjustment processing for suppressing influence of appearance of the protruded part “B” with respect to a normal image. In this processing, first, the control part 10 reads out mask image data from the storage part 11. In addition, the control part 10 reads out image data and renders to the frame buffer. Next, the control part 10 determines whether each pixel of the image in the frame buffer is a portion corresponding to the protruded part “B” or not. For example, the control part 10 performs AND judgment of a corresponding pixel and the above-mentioned mask image data and, when TRUE (1) is obtained, the control unit 10 may determine that the corresponding pixel is the portion corresponding to the protruded part “B”. On the other hand, in other cases, the control part 10 may determine that the corresponding pixel is the portion which does not correspond to the protruded part “B”.

The control part 10 adjusts brightness of the pixel of the portion corresponding to the protruded part “B” of the display part 12 with respect to each pixel in the frame buffer, and/or adjusts a display of the pixel of the portion corresponding to refraction of light in the protruded part “B”.

Specifically, in a case that brightness of the pixel is to be adjusted, the control unit 10 reduces brightness of each color of “R” (Red), “G” (Green) and “B” (Blue) of a pixel, for example, at a predetermined ratio. The predetermined ratio may be, for example, set at a ratio in an extent that light scattering due to a projection of the protruded part “B” is suppressed, for example, the ratio may be set, for example, in a range of several percent through several tens percent depending on brightness setting of the whole screen of a backlight of the display unit 12, organic EL (electroluminescence) and the like. In addition, in a case that brightness of the whole screen is dynamically changed based on a value of an illuminance sensor, the control unit 10 may dynamically change the ratio for reducing brightness to a value corresponding to the change.

In addition, the control part 10 may perform deformation with respect to pixels of the portion corresponding to the protruded part “B” depending on refraction of light due to a convex lens shape of the protruded part “B”. Specifically, even when a pixel of the corresponding portion is enlarged, the control unit 10 may deform the pixel so as to appear the same shape and adjust the appearance. In this embodiment, when pixels of respective colors are disposed in a stripe or a checker arrangement, the control part 10 may be capable of performing change of brightness or deformation depending on a difference of positions, chromatic aberration and the like. In this case, for example, it is preferable that the control part 10 adjusts appearance so that brightness and a hue when the display unit 12 is viewed from a front side are similar to an image before adjustment.

Further, the control part 10 may execute adjustment with respect to the pixels of the portion corresponding to the protruded part “B” for respective frames in a case that an image is temporally changed such as an input screen of a moving image and a signature, or in a case of a double buffer, and the like. In this case, the control part 10 does not need to perform changing of a portion where brightness of a pixel does not change.

The screen 500-2 in FIG. 4B is an example of rendering in which brightness of each of a protruded portion in a lattice shape corresponding to the protruded part “B”, a portion of the center projection of the numeral “5”, portions of the symbols “∘” (confirm), “X” (cancel) and “<” (return) is reduced and adjusted.

### (Step S105)

Next, the control part 10 determines whether or not to end the display processing. When all the images have been displayed, the control part 10 determines “Yes”. On the other hand, when all the images have not been displayed yet, the control part 10 determines “No”. In the case of “Yes”, the control part 10 ends the image display adjustment processing. In the case of “No”, the control part 10 returns the processing to the step S102 and continues rendering. In this manner, the image display adjustment processing in accordance with an embodiment of the present invention is finished.

### Principal Effects in this Embodiment

Since this embodiment is configured as described above, the following effects can be obtained. Conventionally, when a credit card or the like is to be used, the PIN is often required to be inputted. Especially, in a manned POS settlement terminal, some countries have regulations in which a boundary of each button is made to be distinctive and a projection is provided on the numeral “5” button of number input buttons so that a visually-impaired person is also capable of recognizing the numeral arrangement of the buttons. However, for reasons of security, numerals and the like are unable to be read aloud.

When a conventional button type PIN input device is changed to a display type device, although easiness of surface cleaning and the like are improved, the device is difficult for a visually-impaired person to use. In order to prevent the problem, like a cell-phone described in Patent Literature 1, when a projection or the like made of plastic is provided, the projection may cause irregular reflection of light and thereby, display deterioration may occur, that is, an image displayed in the protruded portion may become difficult to be seen. In other words, when the device displays, in addition to an input screen for the PIN, advertisements such as a moving image or a still image, selection of settlement methods, a settlement result, and the like, the projection causes irregular reflection of light and a surface of the projection becomes difficult to be seen.

On the other hand,
(1) A card reader 1 in accordance with an embodiment of the present invention is an input device for acquiring input information related to a medium, the input device is characterized in that:
   a display part 12 which is capable of displaying images including icons for inputting the input information;
   an input part 13 which acquires a position of an icon of the display part 12 as the input information when the position of the icon is instructed; and
   a control part which acquires the input information from the input part 13 and controls the display part 12;
   where the display part 12 is formed with a protruded part “B” in a portion indicating a boundary position and/or a center position of an icon, and the control part adjusts appearance of a portion corresponding to the protruded part “B” of the image.

As described above, in the card reader 1, the protruded part “B” is formed in a portion indicating a boundary position of a plurality of icons which display for inputting information related to a medium to the display part 12, and the control part is configured to include an image adjustment part which adjust appearance of an image in a portion corresponding to the protruded part “B”. As a result, even in a case that the protruded part “B” is formed for a visually-impaired person, when brightness of an image of a portion corresponding to the protruded part “B” is adjusted, irregular reflection due to the protruded part “B” is suppressed, and a displayed image can be less likely to be affected by the protruded part “B”. Therefore, an input device can be provided which is capable of suppressing influence due to that a displayed image becomes difficult to be seen by the protruded part “B”.

Further,
(2) In the card reader 1 in this embodiment, the input device described in the above-mentioned structure (1) is characterized in that the icon is an input symbol image of a numeral, character or symbol.

According to this structure, in a case that a button icon is drawn on a display by an input symbol image of a numeral, character or symbol for PIN input, the protruded part “B” is formed in a portion indicating a boundary of the icon and the numeral “5”, and the like. Therefore, in a display type input device, even a visually-impaired person is capable of grasping and recognizing number arrangement of buttons by the protruded part “B”. In addition, a normal image can be prevented from becoming difficult to be seen by the protruded part “B”. Therefore, display quality can be enhanced while being user-friendly.

Further,
(3) In the card reader 1 in this embodiment, the input device described in the above-mentioned structure (1) or (2) is characterized in that the control part 10 adjusts brightness of a portion corresponding to the protruded part “B” of the display part 12, and/or adjusts a display of a portion corresponding to refraction of light in the protruded part “B”.

According to this structure, in a case that advertisements such as a moving image or a still image, selection of settlement methods and a settlement result are to be displayed, when brightness adjustment of “RGB” in a portion of the protruded part “B”, in other words, processing by which brightness is reduced is performed on an image to be displayed, irregular reflection is suppressed and appearance of the image can be smoothed. Further, when deformation processing or the like is performed on a portion of a convex lens, a feeling of strangeness with respect to the protruded part “B” can be suppressed. When the above-mentioned processing is performed, in a case that a display of a settlement device is viewed from a front side, unevenness becomes relatively difficult to be seen and thus, a user is capable of seeing an advertisement without a feeling of strangeness and performing an operation by using a settlement selection screen.

### OTHER EMBODIMENTS

In the embodiment described above, an example of the protruded part “B” is described in which a projection in a lattice shape is formed in a boundary of each icon. However, as the protruded part “B”, it may be structured that a square or circular frame or the like is formed in a boundary of an icon of the display part 12, a square or circular projection showing a button position is formed on an icon, and braille, numeral, character or symbol is directly formed on an icon. In addition, instead of protruding a frame portion as a projection like the above-mentioned protruded part “B”, on the contrary, it may be structured that a portion of the whole icon is formed to be a protruded part, and the frame portion is formed to be a recessed part

Further, in the above-mentioned embodiment, the protruded part “B” is formed of inkjet resin. However, unevenness may be formed by shaving (edging) plastic or glass, or by attaching a transparent member such as a frame or a button on the display part 12. Further, it may be structured that a fluid such as transparent oil is introduced into a micro passage printed on a protective sheet on the display part 12 by a pump to dynamically form the protruded part “B” only in a necessary case such as PIN input and the like of a visually-impaired person.

According to the above-mentioned structure, display can be adjusted according to durability, a manner of usage and the like of the input device. As a result, various structures can be handled.

Further, in the above-mentioned embodiment, when an adjusted image is to be displayed, normal rendering processing is performed and appearance adjustment is not performed. However, also in this case, the appearance adjustment processing may be performed. Alternatively, it may be configured that appearance adjustment is not performed on a frame portion of an icon, and the appearance adjustment processing is performed only on the protruded part “B” formed on the button “5”. In addition, the processing when an adjusted image is to be prepared may be included in the image display method and the image display adjustment processing in accordance with an embodiment of the present invention. In other words, an adjusted image may be automatically created from mask image data

Further, in the above-mentioned embodiment, in an input screen of the PIN, an image of the whole keypad is prepared as an adjusted image. However, when an icon is to be drawn, rendering may be performed by changing display coordinates, area and the like of an image of each icon so as to be in a layout avoiding the protruded part “B”. In other words, for example, the icons may be disposed so as to avoid lattice portions. In addition, the processing may be dynamically applied to an image acquired from the host apparatus 3.

According to the above-mentioned structure, even in a case that a design of an icon is changed, a display can be obtained in which the protruded part “B” is avoided and which is easily seen. Alternatively, even in a case that a layout and the like of a protective sheet of the protruded part “B” are changed, the situation can be handled.

Further, in the above-mentioned embodiment, as an example, brightness of the protruded part “B” is reduced according to brightness of the whole screen. However, appearance of a display may be adjusted so as to reduce brightness only when scattering is conspicuous or visibility is enhanced according to brightness of the whole screen. For example, the appearance adjustment processing is not required to be performed in a case that the periphery is dark and brightness of the whole screen is low, or in a case that brightness of the whole screen is increased to a value near to the maximum in the daytime. Alternatively, in a case that high contrast display is to be performed for a visually-impaired people, the appearance adjustment processing is not required to be performed. Further, brightness adjustment processing may be dynamically performed according to brightness of pixels around the protruded part “B” within the image or brightness of the whole image, and the like.

According to the configuration described above, appearance of an image is made further naturally and display quality can be further enhanced.

Further, in the above-mentioned embodiment, an icon includes images of input symbols of a numeral, character or symbol, and especially includes touch button images. However, the input symbol may be a pictograph other than a numeral, character or symbol, and is not necessarily a button image. For example, the input symbol includes a symbol indicating a description area for a signature, an area showing gesture recognition, an area for fingerprint authentication, a touch area of a non-contact medium, and the like.

According to the configuration described above, various inputs related to settlement can be handled.

In the above-mentioned embodiment, as an example, a single card reader 1 is used as an input device. However, also in a card reader which is integrated with other types of apparatuses such as a POS apparatus, ticket vending apparatus, ticket examination apparatus, and gate apparatus, the processing in this embodiment can be performed. In addition, this embodiment may be applied to a device, which is not provided with the information reading and writing part 14 such as a single PIN pad, as an input device. In this case, input of the PIN and the like can be performed for settlement by combining with another single card reader.

Further, in the above-mentioned embodiment, as an example, the display part 12 is a liquid crystal display, an organic electroluminescence display or the like. However, this embodiment may be applied to a flat surface type PIN input device which includes a backlight or a rear side transmissive image panel.

According to this structure, a flexible structure can be attained. Therefore, convenience of a user can be enhanced.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. An input device for acquiring input information related to a medium, the input device comprising:
a display part which is capable of displaying images including icons for inputting the input information;
an input part which acquires a position of an icon of the display part as the input information when the position of the icon is instructed; and
a control part which acquires the input information from the input part and controls the display part;
wherein the display part is formed with a protruded part in a portion indicating a boundary position and/or a center position of an icon, and
the control part adjusts appearance of a portion corresponding to the protruded part of the image.

2. The input device according to claim 1, wherein the icon is an input symbol image of a numeral, a character or a symbol.

3. The input device according to claim 1, wherein the control part adjusts brightness of a portion corresponding to the protruded part of the display part, and/or adjusts a display of a portion corresponding to refraction of light in the protruded part.

4. An image display method performed by an input device for acquiring input information related to a medium, wherein
the input device comprises:
a display part which is capable of displaying images including icons for inputting the input information;
an input part which acquires a position of an icon of the display part as the input information when the position of the icon is instructed; and
a control part which acquires the input information from the input part and controls the display part,
the display part is formed with a protruded part in a portion indicating a boundary position and/or a center position of an icon, and
appearance of a portion corresponding to the protruded part of the image is adjusted.

5. A program executed by an input device for acquiring input information related to a medium, wherein
the input device comprises:
a display part which is capable of displaying images including icons for inputting the input information;
an input part which acquires a position of an icon of the display part as the input information when the position of the icon is instructed; and
a control part which acquires the input information from the input part and controls the display part,
the display part is formed with a protruded part in a portion indicating a boundary position and/or a center position of an icon, and
appearance of a portion corresponding to the protruded part of the image is adjusted by the control part.
